(19) United States
(12) Patent Application Publication
(10) Pub. No.: US 2012/0238710 A1
(43) Pub. Date: Sep. 20, 2012

(54) AMINE ADDUCTS

(76) Inventors: Markus Schroetz, Ochsenhausen (DE); Marcus Hummel, Mietingen-Baltringen (DE); Ludwig Huelskaemper, Attenweiler (DE)

(21) Appl. No.: 13/509,808

(22) PCT Filed: Nov. 12, 2010
(86) PCT No.: PCT/US10/02961

§ 371 Date: May 15, 2012

Related U.S. Application Data
(60) Provisional application No. 61/281,391, filed on Nov. 17, 2009.

(51) Int. Cl. C08G 59/14; C08L 63/00

(52) U.S. Cl. 525/526; 525/523

(57) ABSTRACT

Embodiments include an amine adduct obtainable by reacting an amine compound having at least two amino groups and a monoalkylpolyalkylene glycidyl ether having the formula (C₂H₃O)—CH₂—O—(CH₂—(CHR¹)—O)ₙ, —R², wherein n is 1 to 50, each R¹ is independently H or CH₃, and R² is an alkyl group. Embodiments include a curable composition including a resin component and a hardener component that includes the amine adduct.

### FIELD OF DISCLOSURE

The present disclosure relates to amine adducts, and in particular amine adducts.

### BACKGROUND

Epoxy systems consist of two components that can chemically react with each other to form a cured epoxy, which is a hard, inert material. The first component is an epoxy resin and the second component is a curing agent, sometimes called a hardener. Epoxy resins include compounds that contain epoxide groups. The hardeners include compounds that are reactive with the epoxide groups of the epoxy resins.

The epoxy resins can be crosslinked, also referred to as curing, by the chemical reaction of the epoxide groups and the compounds of the hardener. This curing converts the epoxy resins, which have a relatively low molecular weight, into relatively high molecular weight materials by chemical addition of the compounds of the hardener. The hardener can contribute to many of the properties of the cured epoxy.

The rate of cure of epoxy systems is in part dependent on the reactivity of the epoxy resin and the hardener, and in part dependent on the temperature of the cure. For some epoxy systems relatively higher temperatures will increase the rate of cure, while relatively cooler temperatures will decrease the rate of cure. The minimum temperature at which epoxy systems can cure is a parameter that is considered when selecting an epoxy system for certain applications. In some applications, an accelerator is used to increase the rate of cure, or help provide that the epoxy system can cure at a temperature which is lower than the optimal curing temperature for that epoxy system. For some applications curing of epoxy systems at ambient temperature is important.

The decreased rate of cure can increase the risk of blushing during the crosslinking. Blushing, sometimes also referred to whitening, can occur when moisture, such as atmospheric water or water that originates from within a porous substrate, reacts with a curable composition having a hardener that includes an amine compound. Amine compounds on the surface of the curable composition can combine with carbon dioxide and the water to form hydrates of amine carbonate. The amine compounds, which were intended to react with the epoxide groups of the epoxy resins, are consumed and thus not all epoxy resins can crosslink during curing. Blushing can produce white patches or hazy effect portions in clear coatings. This can contribute to discoloration or yellowing over time, and may cause lack of gloss in pigmented coatings. Furthermore, blushing can affect the coating performance and result in poor overcoatability. Poor overcoatability is the insufficient adhesion of a subsequent coating layer due to a surface energy modification associated with the blushing.

### SUMMARY

The present disclosure provides one or more embodiments of amine adducts. For one or more of the embodiments, the amine adducts are obtainable by combining an amine compound having at least two amino groups and a monoalkylpolyalkylene glyc idyl ether having the formula (C₂H₃O)—CH₂—O—(CH₂—(CHR¹)—O)ₙ—R², wherein n is 1 to 50, each R¹ is independently H or CH₃, and R² is an alkyl group.

For one or more of the embodiments, the present disclosure provides curable compositions including a resin component and a hardener component. The resin component includes an epoxy compound that is selected from the group consisting of aromatic epoxy compounds, alicyclic epoxy compounds, aliphatic epoxy compounds, and combinations thereof. The hardener component includes the amine adduct, as discussed herein.

### DETAILED DESCRIPTION

Embodiments of the present disclosure provide amine adducts. The amine adducts can be included in a hardener component of curable compositions that also include a resin component. The amine adducts are less hygroscopic and have a lower vapor pressure compared to some non-adducted amines, as discussed herein, and can help prevent blushing.

An adduct is a compound that that is formed from a combination of two or more separate compounds. The combination can be a chemical reaction, such as an addition reaction. A compound is a substance composed of atoms or ions of two or more elements in chemical combination. Herein, two separate compounds that can be combined to form the amine adduct are an amine having at least two amino groups and a monoalkylpolyalkylene glycidyl ether. An amine is a compound that contains an N—H moiety. The two separate compounds can be combined such that there is change in connectivity, but no loss of atoms within the compounds.

For one or more of the embodiments, the monoalkylpolyalkylene glycidyl ether has the formula (C₂H₃O)—CH₂—O—(CH₂—(CHR¹)—O)ₙ—R², wherein n is 1 to 50, each R¹ is independently H or CH₃, and R² is an alkyl group. The monoalkylpolyalkylene glycidyl ether can be prepared by a chemical reaction of epichlorohydrin and an alkylpolyethylene glycol ether. The chemical reaction can occur at a temperature from 30 degrees Celsius (° C.) to 120° C. Additionally, the chemical reaction can include a Lewis acid. An example of the Lewis acid includes, but is not limited to, boron trifluoride bis-diethyl etherate. The chemical reaction can include sodium hydroxide, which can facilitate ring closure that occurs via the chemical reaction. Following the chemical reaction sodium chloride can be removed via separation. Examples of other chemicals that can be employed in the preparation of the monoalkylpolyalkylene glycidyl ether include, but are not limited to, toluene and triethylbenzylammonium chloride that can be useful for ring closure and/or a subsequent phase separation.

For one or more of the embodiments a molar ratio of 1:1, epichlorohydrin to alkylpolyethylene glycol ether, can employed when forming the monoalkylpolyalkylene glycidyl ether. However, molar ratios other than 1:1, epichlorohydrin to alkylpolyethylene glycol ether, are possible when forming the monoalkylpolyalkylene glycidyl ether. A molar excess of epichlorohydrin can result in increased formation of diglycidyl ethers, and a molar excess of alkylpolyethylene glycol ether can result in increased reactive, unreacted polyalkylene glycols in the product.

For one or more of the embodiments, the alkylpolyethylene glycol ether is an isotridecanol ethoxylate. The long-chain alcohol of the isotridecanol ethoxylate can be based on a twelve carbon olefin prepared by trimerisation of n-butene. The hydroformylation (oxo synthesis) of the olefin with carbon monoxide and hydrogen can produce an isomeric mixture of primary isotridecyl alcohols with a branched alkyl chain. The alkylpolyethylene glycol ether can be formed by reacting isotridecanol with varying amounts of an oxide, as shown in Reaction 1, where m is an integer from 3 to 12, which indicates the average degree of ethoxylation, and R is a branched thirteen carbon alkyl. The oxide can be selected from the group consisting of ethylene oxide, propylene oxide, and combinations thereof.

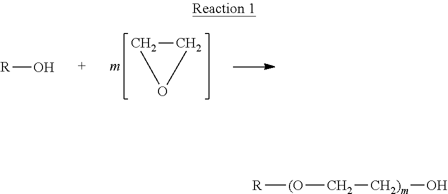

For one or more of the embodiments, examples of amines having at least two amino groups include, but are not limited to, polyethylenepolyamines, polypropylenepolyamines, aliphatic amines, cycloaliphatic polyamines, heterocyclic polyamines, aromatic amines, and polyaminoamides optionally containing imidazoline groups. Examples of polyethylenepolyamines include, but are not limited to, diethylenetriamine, triethylenetetramine, and tetraethylenepentamine. Examples of polypropylenepolyamines include, but are not limited to, dipropylenetriamine, tripropylenetetramine, and polyamines obtained by cyanoethylation of polyamines. Examples of aliphatic amines include, but are not limited to, diaminoethane, diaminopropane, neopentanediamine, diaminobutane, hexamethylenediamine, and 2,2,4(2,4,4)-trimethylhexamethylene-1,6-diamine. Examples of cycloaliphatic amines include, but are not limited to, isophoronediamine, diaminocyclohexane, norbornanediamine, 3(4),8(9)-bis(aminomethyl)tricyclo [5,2,I,O] decane, (TCD-diamine), 1,3-bis(aminomethyl)cyclohexane, bis(aminomethylcyclohexyl)methane. Examples of heterocyclic polyamines include, but are not limited to, N-aminoethylpiperazine, and 1,4-bis(aminopropyl)piperazine. An example of an aromatic amine includes, but is not limited to, diaminodiphenylmethane. It is possible to use a combination of amines for the amine adducts.

The amine adducts can be prepared by a process that includes adding the monoalkylpolyalkylene glycidyl ether, as discussed herein, dropwise to an amine. The dropwise addition occurs at a temperature that is maintained in a range of from 50° C. to 200° C. while stirring. The dropwise addition can occur in an inert environment. An example of the inert environment includes, but is not limited to, a nitrogen environment. The temperature maintenance and stirring can be continued for about one hour after the dropwise addition is completed. However, the amine adducts can be prepared by other processes. For one or more of the embodiments, a molar ratio in a range of from 1:1.5 to 1:10, monoalkylpolyalkylene glycidyl ether to amine, is employed when forming the amine adducts. However, other molar ratios, monoalkylpolyalkylene glycidyl ether to amine, are possible when forming the amine adducts.

Excess amine may be present after the amine adducts have been prepared. The excess amine may contribute to blushing. The amine adducts can be isolated via a separation process, such as distillation. The amine adducts that have been isolated via the separation process can impart an increased viscosity, influence flow properties, extend pot life and/or improve adhesion characteristics of some the curable compositions as compared to some other compositions having hardener components that include the excess amine and/or some non-adducted amines.

As discussed herein, the curable compositions include a resin component. For one or more of the embodiments, the resin component includes an epoxy compound, which refers to a compound in which an oxygen atom is directly attached to two adjacent or non-adjacent carbon atoms of a carbon chain or ring system.

The epoxy compound is selected from the group consisting of aromatic epoxy compounds, alicyclic epoxy compounds, aliphatic epoxy compounds, and combinations thereof. Examples of aromatic epoxy compounds include, but are not limited to, glycidyl ether compounds of polyphenols, such as hydroquinone, resorcinol, bisphenol A, bisphenol F, 4,4′-dihydroxybiphenyl, novolac, tetrabromobisphenol A, 2,2-bis(4-hydroxyphenyl)-1,1,1,3,3,3-hexafluoropropane, and 1,6-dihydroxynaphthalene.

Examples of alicyclic epoxy compounds include, but are not limited to, polyglycidyl ethers of polyols having at least one alicyclic ring, or compounds including cyclohexene oxide or cyclopentene oxide obtained by epoxidizing compounds including a cyclohexene ring or cyclopentene ring with an oxidizer. Some particular examples include, but are not limited to hydrogenated bisphenol A diglycidyl ether; 3,4-epoxycyclohexylmethyl-3,4-epoxycyclohexyl carboxylate; 3,4-epoxy-1-methylcyclohexyl-3,4-epoxy-1-methylhexane carboxylate; 6-methyl-3,4-epoxycyclohexylmethyl-6-methyl-3,4-epoxycyclohexane carboxylate; 3,4-epoxy-3-methylcyclohexylmethyl-3,4-epoxy-3-methylcyclohexane carboxylate; 3,4-epoxy-5-methylcyclohexylmethyl-3,4-epoxy-5-methylcyclohexane carboxylate; bis(3,4-epoxycyclohexylmethyl)adipate; methylene-bis(3,4-epoxycyclohexane); 2,2-bis(3,4-epoxycyclohexyl)propane; dicyclopentadiene diepoxide; ethylene-bis(3,4-epoxycyclohexane carboxylate); dioctyl epoxyhexahydrophthalate; and di-2-ethylhexyl epoxyhexahydrophthalate.

Examples of aliphatic epoxy compounds include, but are not limited to, polyglycidyl ethers of aliphatic polyols or alkylene-oxide adducts thereof, polyglycidyl esters of aliphatic long-chain polybasic acids, homopolymers synthesized by vinyl-polymerizing glycidyl acrylate or glycidyl methacrylate, and copolymers synthesized by vinyl-polymerizing glycidyl acrylate or glycidyl methacrylate and other vinyl monomers. Some particular examples include, but are not limited to glycidyl ethers of polyols, such as 1,4-butanediol diglycidyl ether; 1,6-hexanediol diglycidyl ether; a triglycidyl ether of glycerin; a triglycidyl ether of trimethylol propane; a tetraglycidyl ether of sorbitol; a hexaglycidyl ether of dipentaerythritol; a diglycidyl ether of polyethylene glycol; and a diglycidyl ether of polypropylene glycol; polyglycidyl ethers of polyether polyols obtained by adding one type, or two or more types, of alkylene oxide to aliphatic polyols such as propylene glycol, trimethylol propane, and glycerin; and diglycidyl esters of aliphatic long-chain dibasic acids.

The epoxy compound can contain, on average, more than one oxygen atom per molecule. Epoxy compounds, which can be useful for one or more of the embodiments of this disclosure, can be found in A. M. Paquin, “Epoxidverbindungen and Epoxidharze”, Springer-Verlag, Berlin, (1958), and/or in Lee, “Handbook of Epoxy Resins”, (1967). For one or more of the embodiments, a mixture of two or more different epoxy compounds can be employed.

As discussed herein, the curable composition includes a hardener component that includes the amine adduct. For one or more embodiments, the amine adduct is 20 weight percent to 100 weight percent of a total weight of the hardener component.

Surprisingly, the curable composition, as described herein, does not completely crosslink at an ambient temperature in a range of from 20 degrees Celsius (° C.) to 25° C. At ambient temperature and a relative humidity of 50% the curable composition achieves a degree of crosslinking that is in a range of 50 percent to 70 percent of a completely crosslinked state that can be achieved by curing the curable composition at a curing temperature of 80° C. at a relative humidity of 50% for a curing period of 16 hours. A cured composition that has a Shore D hardness that is at least 95% of a Shore D hardness of a cured composition in the completely crosslinked state can be considered to be completely crosslinked, also referred to fully cured. In the completely crosslinked state the cured composition has evolved at least 95% of a theoretical enthalpy of the curing reaction. However, embodiments are not limited to these values and other curing temperatures, relative humidities, and/or curing periods can be employed to achieve the completely crosslinked state of the curable composition. As such, the curable composition is advantageous for applications where a decelerated curing rate, as compared to some other epoxy systems, is useful. For example, the curable composition can be advantageously used for applications where the decelerated curing rate can allow for a greater penetration and/or saturation of the curable composition into a particular medium, as compared to some other epoxy systems.

The curable compositions can include a diluent. The diluent can be a non-reactive diluent, a reactive diluent, or a combination thereof.

The non-reactive diluent can be a compound that does not participate in a chemical reaction with the epoxy compound during the curing process. The non-reactive diluent can be either a compound that substantially evaporates out of the curable compositions during curing, or a compound that substantially remains in the curable compositions after curing. For example, some non-reactive diluents that substantially evaporate out of the curable compositions during curing are xylene, butanol, methoxypropanol, and water. For example, some non-reactive diluents that substantially remain in the curable compositions after curing are high-boiling alcohols and ethers, such as benzyl alcohol, propylene glycol, diethylene glycol monobutyl ether. For some embodiments, the viscosity of the curable compositions can be reduced by addition of the non-reactive diluent.

The reactive diluent can be a compound which participates in a chemical reaction with the epoxy compound during the curing process, and becomes incorporated into the cured composition. Suitable reactive diluents for use with the curable compositions include, but are not limited to, phenyl glycidyl ether, cresyl glycidyl ether, p-tertiary-butyl phenyl glycidyl ether, butyl glycidyl ether, C₁₂-C₁₄ alcohol glycidyl ethers, diethylene glycol monobutyl ether, diethylene glycol monohexyl ether, cyclohexanedimethyl diglycidyl ether, glycidyl ethers based on polyethylene glycols, and polypropylene glycols. For some embodiments, the viscosity of the curable composition can be reduced by addition of the reactive diluent.

The curable compositions can include an additive. Examples of additives include, but are not limited to, fillers, pigments, dyes, stabilizer, flow-control agents, plastication agents, unreactive extender resins, plasticizer, accelerators, modifiers, and combinations thereof. Various particle sizes and/or particle size distributions of the additive can be used for various applications.

### EXAMPLES

The following Examples including amine adducts, amine adducts isolated from excess amine, and curable compositions are given to illustrate, but not limit, the scope of this disclosure. Unless otherwise indicated, all parts and percentages are by weight. Unless otherwise specified, all instruments and chemicals used are commercially available.

Materials

MARLIPAL® O13/30, (alkylpolyethylene glycol ether), available from Sasol.

MARLIPAL® O13/60, (alkylpolyethylene glycol ether), available from Sasol.

Epichlorohydrin, available from The Dow Chemical Company.

Boron trifluoride bis-diethyl etherate (((C₂H₅)₂O)₂.BF₃), (Lewis acid); available from BASF.

Toluene, analytical grade, available from Merck KGaA.

Phosphoric Acid (H₃PO₄), analytical grade, available from Merck KGaA.

Sodium hydroxide (NaOH), analytical grade, available from Merck KGaA.

Triethylbenzylammonium chloride (TEBACl), available from Merck KGaA.

Triethylenetetramine (TETA), (amine), available from Delamine.

POLYPDX® E 403, (aromatic epoxy compound), available from UPPC GmbH.

Deionized water.

Glycidyl Ether Synthesis

Five hundred grams (g) of MARLIPAL® O13/30 and 250 g of MARLIPAL® O13/60 were added to a container and mixed with 8 g boron trifluoride bis-diethyl etherate by stirring. Two hundred twenty two g epichlorohydrin was added dropwise to the container contents over a 2 hour period while the stirring was continued and the temperature of the container contents was maintained at 80° C. The stirring was continued for 30 minutes after the addition of the epichlorohydrin was completed. Six hundred g toluene was added to the container contents. Three hundred sixteen g of a 20 weight percent NaOH solution and 8 g of a 60 weight percent TEBACl solution were added to the container contents over a period of about 1 minute while the container contents were stirred. The stirring was continued for 1 hour after the addition of the NaOH and TEBACI solutions while the container contents were maintained at 85° C., after which the container contents were allowed to settle for 10 minutes. After settling the aqueous phase of the container contents was discarded. One hundred six g of the 20 weight percent NaOH solution and 3 g of the 60 weight percent TEBACI solution were added to the remaining container contents over a period of about 1 minute while the container contents were stirred. The stirring was continued for 1 hour after the addition of the NaOH and TEBACI solutions while the container contents were maintained at 85° C., after which the container contents were allowed to settle for 10 minutes. After settling the aqueous phase of the container contents was again discarded. The remaining container contents were washed to a neutral pH with 55 milliliters (ml) of an 8 weight percent H₃PO₄ solution wash followed by two 50 ml deionized water washings. The washed remaining container contents were distilled to yield 802 g of ether synthesis liquid product having a greenish-yellow color.

The ether synthesis liquid product had an epoxy equivalent weight (EEW) of 529g/equivalent as determined by ASTM D1652; a viscosity of 26 mPa·s at 25° C. as determined by ASTM D445; a Gardner value of 5.3 as determined following ASTM D1544; a refractive index of 1.4554 as determined following ASTM D542; and 828 parts per million (ppm) of easily saponifiable chlorine as determined following DIN EN ISO 21627-2.

### Example 1 and Example 2

### Amine Adduct Synthesis

Five hundred twenty nine g of the ether synthesis liquid product was added to a container and stirred. Three hundred sixteen g of TETA was added dropwise to the container contents over a 1 hour period while the stirring was continued and the temperature of the container contents was maintained at 100° C. to produce Example 1 that is an amine adduct synthesis product.

The amine adduct synthesis product was distilled at 255° C. and 3 millibar (mbar) to produce Example 2 that was an amine adduct isolated from excess amine via distillation. Example 2 had a hydrogen equivalent weight (HEW) of 137 g/equivalent by calculation as the molecular weight divided by the number of sites on a molecule thereof that was capable of opening an epoxy ring; an amine number of 341 milligrams potassium hydroxide per gram (KOH/g) determined by DIN 16594; and a viscosity of 1280 mPa·s at 25° C. s determined by ASTM D445.

### Example 3

### Curable Composition Formation

Example 3 was a curable composition that included 20.76 g of Example 2 that was mixed with 29.24 g of POLYPDX® E 403. This mixture was 1:1, hydrogen equivalent to epoxy equivalent.

Example 3 was exposed to a temperature of 22° C. and a relative humidity of 50% for 168 hours (h). Following the exposure, Example 3 had a Shore D hardness of 42 as determined by ASTM D2240.

Example 3 was then exposed to a temperature of 80° C. and a relative humidity of 50% for 16 h. Following the exposure, Example 3 had a Shore D hardness of 64 as determined by ASTM D2240.

Example 3 had a glass transition temperature of 12° C. as determined by ASTM D3418.

The above procedures provided Example 2, an amine adduct, that had an unexpectedly low viscosity of 1280 mPa·s at 25° C. Additionally, the above procedures provided Example 3, a curable composition, that included the amine adduct. The procedures show that at ambient conditions Example 3 is latent, in that Example 3 does not completely crosslink. At ambient conditions, Example 3 cures to a Shore D hardness of about 65 percent of the completely crosslinked Shore D hardness that was obtained by the exposure at elevated temperature. However, Example 3 did completely crosslink at the elevated temperature of 80° C. to provide a flexible cured composition having a Shore D hardness of 64. This latency is surprising because it is not found in some other epoxy systems having other isolated adducts. This latency provides that the amine adducts and the curable compositions, including Examples 1, 2, and 3, are useful for hot curing applications that cure with the application of heat.

1. An amine adduct obtainable by combining an amine having at least two amino groups and a monoalkylpolyalkylene glycidyl ether having the formula (C₂H₃O)—CH₂—O—(CH₂—(CHR¹)—O)ₙ—R², wherein n is 1 to 50, each R¹ is independently H or CH₃, and R² is an alkyl group; and
isolating the amine adduct from an excess of the amine via a separation process.

2. The amine adduct of claim 1, wherein the monoalkylpolyalkylene glycidyl ether is obtained by a chemical reaction of epichlorohydrin and an alkylpolyethylene glycol ether.

3. The amine adduct of claim 1, wherein the alkyl group has ten to sixteen carbon atoms.

4. The amine adduct of claim 1, wherein the amine compound is selected from the group consisting of polyethylenepolyamines, polypropylenepolyamines, aliphatic amines, cycloaliphatic polyamines, heterocyclic polyamines, aromatic amines, polyaminoamides, and combinations thereof.

5. The amine adduct of claim 1, wherein the alkyl group is branched and has thirteen carbon atoms and the alkylpolyethylene glycol ether is obtained by a chemical reaction of isotridecanol and an oxide that is selected from the group consisting of ethylene oxide, propylene oxide, and combinations thereof.

6. A curable composition comprising a resin component including an epoxy compound that is selected from the group consisting of aromatic epoxy compounds, alicyclic epoxy compounds, aliphatic epoxy compounds, and combinations thereof; and a hardener component including an amine adduct obtainable by combining an amine compound having at least two amino groups and a monoalkylpolyalkylene glycidyl ether having the formula (C₂H₃O)—CH₂—O—(CH₂—(CHR¹)—O)ₙ—R², wherein n is 1 to 50, each R¹ is independently H or CH₃, and R² is an alkyl group and where the amine adduct is isolated from an excess of the amine compound via a separation process.

7. The curable composition of claim 6, wherein the monoalkylpolyalkylene glycidyl ether is obtained by a chemical reaction of epichlorohydrin and an alkylpolyethylene glycol ether, and the alkyl group has ten to sixteen carbon atoms.

8. The curable composition of claim 6, wherein the curable composition has a hardness of 42 on Shore D hardness scale after 168 hours of exposure to a temperature of 22° C. at a 50 percent relative humidity.

9. The curable composition of claim 6, wherein the amine adduct is 20 weight percent to 100 weight percent of a total weight of the hardener component.

10. A product obtained by curing the curable composition of claim 6.
